(19) United States
(12) Patent Application Publication
(10) Pub. No.: US 2018/0170093 A1
(43) Pub. Date: Jun. 21, 2018

(54) FLEXIBLE PIXELATED FABRY-PEROT FILTER

(71) Applicant: SPECTRAL DEVICES INC., London (CA)

(72) Inventors: Mohamadreza NAJIMINAINI, London (CA); Jeffrey John Leslie CARSON, London (CA)

(21) Appl. No.: 15/739,493

(22) PCT Filed: Jun. 29, 2016
(86) PCT No.: PCT/CA2016/050762

§ 371 Date: Dec. 22, 2017

Related U.S. Application Data
(60) Provisional application No. 62/186,760, filed on Jun. 30, 2015.

(51) Int. Cl. B42D 25/29; G02B 5/28; G02B 5/20

(52) U.S. Cl. CPC B42D 25/29; G02B 5/288; G01J 3/26; G02B 5/284; G02B 5/201

(57) ABSTRACT

An apparatus and method of fabrication for flexible pixelated Fabry-Perot filter. The flexible pixelated Fabry-Perot filter can include a first reflective layer, a second reflective layer, a Fabry-Perot cavity layer between the first reflective layer and the second reflective layer, wherein the Fabry-Perot cavity layer includes at least two regions of different cavity thickness, and a flexible substrate layer which structurally supports the first reflective layer, the Fabry-Perot cavity layer, and the second reflective layer. The flexible pixelated Fabry-Perot filter comprises, for example, random or specified mosaic arrangement of blocks, where each block has at least two counts of Fabry-Perot filter, which can act as pixel filters, having resonance transmissions in ultraviolet, visible or near/mid/far infrared regions. The constituent materials and their thicknesses allow the flexibility and fabrication. The flexible pixelated Fabry-Perot filter can be utilized in various applications ranging from color/multispectral imaging to digital color display.

### CROSS-REFERENCE TO RELATED APPLICATION(S)

This application claims the benefit of priority to U.S. Provisional Patent Application No. 62/186,760 filed Jun. 30, 2015 entitled FLEXIBLE PIXELATED FABRY-PEROT FILTER, the contents of which are herein incorporated by reference into the Detailed Description of Example Embodiments herein below.

### TECHNICAL FIELD

At least some example embodiments relate to Fabry-Perot filters, and in particular to a flexible color filter array comprised of Fabry-Perot filters.

### BACKGROUND

Optical band pass filters can be used to restrict the transmission of light to specific spectral bands. Fabry-Perot (FP) interference filters represent one type of optical band pass filter, which are used to transmit light specific to a single or multiple spectral bands. A simple Fabry-Perot filter includes a cavity layer and a partially reflective layer on both sides of the cavity. Based on the cavity thickness and its refractive index, the FP transmission resonance is tuned to a desired spectral band. Using currently available manufacturing methods, fabrication of a single Fabry-Perot filter is straightforward and inexpensive. However, fabrication of a color filter array of Fabry-Perot filters on the same substrate is complex and costly. One of the simplest color filter arrays utilizes the Bayer model, but more complex color filter arrays are desired for high definition color imaging, multispectral imaging, optical filtering applications, and digital color display applications. Therefore, industry has developed methods to manufacture color filter arrays of Fabry-Perot filters, or so called pixelated Fabry-Perot filter, on hard substrates such as glass for a variety of imaging, filtering, and display applications. Fabrication of pixelated Fabry-Perot filters involves one or more lithography, deposition, and etching steps. Hard materials such as SiO2 and Si3N4 are commonly used as cavity layers. Although dyes have commonly been used to manufacture color filter arrays for color imaging and digital displays, they tend to be expensive, do not have optimal transmission efficiency, and do not offer narrow band optical filtering. Color filter arrays based on nanostructures require expensive and time-consuming fabrication processes to achieve high-quality across large devices. Fabrication of large arrays of nanostructures suitable for bonding to image sensors is therefore high in cost and not suited to mass production. Roll-to-roll fabrication of large scale arrays of nanostructures is possible; however, the resultant devices suffer from structural defects that cause poor transmission efficiency. Color filter arrays based on the Fabry-Perot effect have been produced with a complex and expensive multi-step process that uses lithography, etching, and deposition of inorganic materials such as SiO2 and Si3N4. Furthermore, the cost increases dramatically as the number of wavelength distinct Fabry-Perot filters in the color filter array increases. Therefore, some existing multispectral imagers based on Fabry-Perot color filter arrays are often too expensive for consumer-based applications.

Additional difficulties with existing filters and devices may be appreciated in view of the Detailed Description of Example Embodiments, below.

### SUMMARY

In an example embodiment, there is provided a flexible Fabry-Perot filter, including: a first reflective layer; a second reflective layer; a Fabry-Perot cavity layer between the first reflective layer and the second reflective layer, wherein the Fabry-Perot cavity layer includes at least two regions of different cavity thickness; and a flexible substrate layer which structurally supports the first reflective layer, the Fabry-Perot cavity layer, and the second reflective layer.

In an example embodiment, there is provided a method for fabricating a flexible Fabry-Perot filter, the method including: fabricating a Fabry-Perot cavity layer directly or indirectly on a surface of a master substrate, wherein the Fabry-Perot cavity layer includes at least two regions of different cavity thickness, wherein the surface of the master substrate corresponds to the different cavity thickness; fabricating a first reflective layer on one surface of the Fabry-Perot cavity layer; and fabricating a second reflective layer on an opposing surface of the Fabry-Perot cavity layer.

In an example embodiment, there is provided an apparatus including a flexible pixelated Fabry-Perot filter where each pixel provides band pass filtering in a specific spectral range based on material composition and cavity length selection. Each pixel includes at least one cavity and a reflective mirror on each face of the cavity. The constituent materials of each pixelated Fabry-Perot filter are flexible materials such as polymers and thin films. The flexible pixelated Fabry-Perot filter is comprised of blocks of pixels, where each block has at least two pixels and the spectral band of each pixel is chosen based on the needs of the application.

In accordance with an example embodiment, there is provided a method for fabricating a flexible pixelated Fabry-Perot filter. The method includes: manufacturing a flexible pixelated Fabry-Perot filter from a master substrate, which includes non-adhesive material deposition, first reflective mirror deposition, cavity deposition and planarization, deposition of a second reflective mirror, flexible substrate formation, and stripping the flexible pixelated Fabry-Perot filter from the master substrate.

In accordance with an example of an embodiment, there is provided a method for fabricating a pixelated Fabry-Perot filter onto a final substrate. The method includes: transferring a pixelated Fabry-Perot filter from a master substrate onto a final substrate, which includes non-adhesive material deposition, first reflective mirror deposition, cavity deposition and planarization, deposition of a second reflective mirror onto a final substrate, bonding the master substrate and the final substrate, and detaching the pixelated Fabry-Perot filter from the master substrate transferred onto the final substrate.

In accordance with an example embodiment, the master substrate for replicating the pixelated Fabry-Perot filter can be used many times for fabricating similar apparatus with the same cavity thickness or different cavity thicknesses. The same master can be used to fabricate different pixelated Fabry-Perot filters ranging from ultraviolet (UV), visible, near-infrared (NIR), mid-infrared (MIR), and far-infrared (FIR) by changing the thickness of the cavity. More importantly, for example, the replication process is not adversely affected by the number of pixels, the number of blocks, or the size of the pixelated Fabry-Perot.

Example embodiments of the apparatus may be utilized as a color filter array in color and multispectral imaging, digital color display, and security band note applications. Due to the flexibility of the flexible pixelated Fabry-Perot filter, it is well-suited to flexible and curved displays.

### BRIEF DESCRIPTION OF THE DRAWINGS

Embodiments will now be described by way of examples with reference to the accompanying drawings, in which like reference numerals are used to indicate similar features, and in which:

FIG. 1 is a perspective view of a flexible pixelated Fabry-Perot filter with subsets of blocks comprising 4 pixels, in accordance with an example embodiment;

FIG. 2(a) is a perspective view of an example of a flexible pixelated Fabry-Perot filter containing four blocks where each block consists of 4 different pixels;

FIG. 2(b) is a perspective view of an example of a flexible pixelated Fabry-Perot filter containing four blocks where each block consists of 16 different pixels;

FIG. 3 is a perspective view of an example of a flexible pixelated Fabry-Perot filter attached to a secondary substrate;

FIG. 4 is a method for fabricating a flexible pixelated Fabry-Perot filter, in accordance with an example of embodiment;

FIG. 5 is the monochromatic reflection image of a master substrate having four different cells with mosaic arrangements of blocks;

FIG. 6(a) is a monochromatic trans-illuminated image of the flexible pixelated Fabry-Perot filter with repeating blocks of four different pixels;

FIG. 6(b) illustrates a graph of optical transmission spectra of the fabricated flexible pixelated Fabry-Perot filter;

FIG. 7 is a color image (originally) and a multispectral images of various concentrations of methylene blue in quartz cuvettes;

FIG. 8 is the monochromatic trans-illuminated image of a flexible pixelated Fabry-Perot filter having repeating sets of blocks where each block contains 16 different pixels;

FIG. 9 is a method for fabricating a pixelated Fabry-Perot filter on a final substrate, in accordance with an example of embodiment; and

FIG. 10 is the monochromatic trans-illuminated image of a pixelated Fabry-Perot filter on a glass substrate having repeating sets of blocks where each block contains 16 different pixels.

### DETAILED DESCRIPTION OF EXAMPLE EMBODIMENTS

For forming color filter arrays for color/multispectral imaging, digital displays, and security documents, various technologies have been utilized for improving performance and cost-effectiveness of the related filtering applications. Miller Harris R. in SPIE 3678 (2): 1083-1090 (1999) teaches how to fabricate a dye-based color filter array directly onto a monochromatic imaging sensor to convert it to a color imaging sensor. Najiminaini et. al. Sci. Rep. 3, 2589 (2013) teaches how to utilize a pixelated metallic nanostructure as a color filter array to enable snap-shot multispectral imaging with a monochromatic camera. Furthermore, Jiang et al., U.S. Patent Application 2015/0042702 (2015) teaches how to use a color filter array of metallic nanostructures as a nano-media display for security and banknote applications. Matsuyama et. al. in U.S. Pat. No. 5,633,739 A (1997) teaches that a color filter array of dyes can be fabricated by thermal dye transfer onto an LCD display resulting in a digital color display. Geelen et. al. WO patent 2013064510 A1 (2013) and Tack et. al. WO patent 2011064403 A1 (2011) teach how to fabricate the pixelated Fabry-Perot filter with multiple etching, lithography and deposition directly onto CMOS imaging sensor chip. Also, Buchsbam et. al. U.S. Pat. No. 5,711,889 (1998) teaches a method for fabricating dichroic filter arrays on glass, which is later bonded to a detector array. All of these references are herein incorporated by reference.

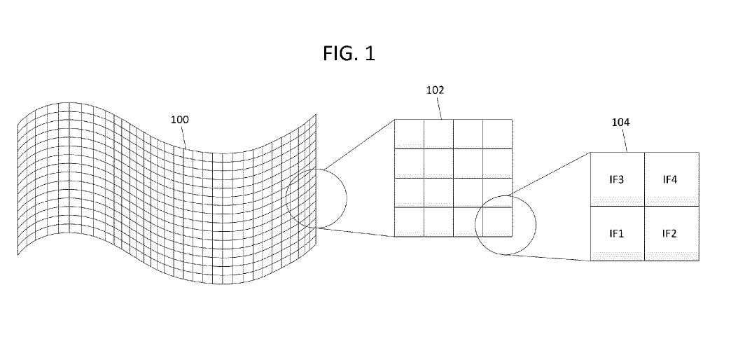

Reference is now made to FIG. 1, which illustrates a perspective view of a flexible pixelated Fabry-Perot filter 100 with 16 blocks 102 in a square arrangement, in accordance with an example embodiment, where each block 102 consists of 4 pixels 104 in a mosaic arrangement. Each pixel 104 comprises a flexible Fabry-Perot filter and behaves as a wavelength separation device. Each pixel 104 in a specific block 102 can transmit one or multiple spectral bands in UV, visible, and near, mid and far infrared. Each block 102 is, for example, identical to the other blocks 102 in the flexible pixelated Fabry-Perot filter 100 since each block 102 consists of, for example, the same arrangement of pixels 104 and pixel 104 structures. Each pixel 104 size can be in a range of 500 nm and can extend typically up to many microns, or even millimeters depending on the application. The pixels 104 can be in contact or spaced apart. Pixels 104 can be, for example, arranged in a square or a rectangular arrangement. Each pixel 104 in a block 102 may have one or a few different geometrical parameters than the other pixels 104 in a block 102. Each pixel 104 may have different optical transmission properties compared to the other pixels 104 in a block 102. This means that each pixel 104, for example, transmits light at a different spectral band than the other pixels 104. However, spectral transmission band of one or more pixels 104 in a block 102 may overlap the spectral transmission of other pixels 104 in the block 102. Each block 102 comprises at least two pixels 104 and, for example, has a square or a rectangular arrangement. Each block 102 can separate light into a number of spectral bands equivalent to the number of the pixels 104 in each block 102. Adjacent blocks 102 can be in contact or spaced apart. A pixelated Fabry-Perot filter 100 can contain one block 102, blocks 102 in one dimension, blocks 102 in a 2D rectangular or square arrangement, or blocks 102 in a random arrangement, in some example embodiments. Other arrangements of blocks 102 are possible. Each block 102 of a pixelated Fabry-Perot filter 100 can contain one, two, or a greater number of pixels 104.

Each block 102 can be referred to as a pixel block or a pixel set, for example. In some example embodiments, each block 102 is defined by a particular set of pixels 104 which are exclusive to the other blocks 102. In some example embodiments, each block 102 includes a set of pixels 104 which are of the same types as the set of pixels 104 for another one of the blocks 102. The meaning of same types can include, for example, the same respective cavity thickness and surrounding materials. The meaning of same types can also include, for example, the same arrangement order of the pixels 104, for example in the same arrangement in a grid or row. In another example embodiment, the set of pixels 104 is of the same types for all of the blocks 102.

In some example embodiments, the pixels may be of a size and/or proximity to each other such that they can still be individually detectable by a detector such as complementary metal-oxide-semiconductor (CMOS) detectors or charge-coupled device (CCD) detector. In some example embodiments, each block 102 may have pixels 104 which are of a size and/or proximity to each other so that the aggregate image of one type of pixel can still be reasonable perceivable and/or has useful (processable) information or characteristics, e.g. by a person or a computer.

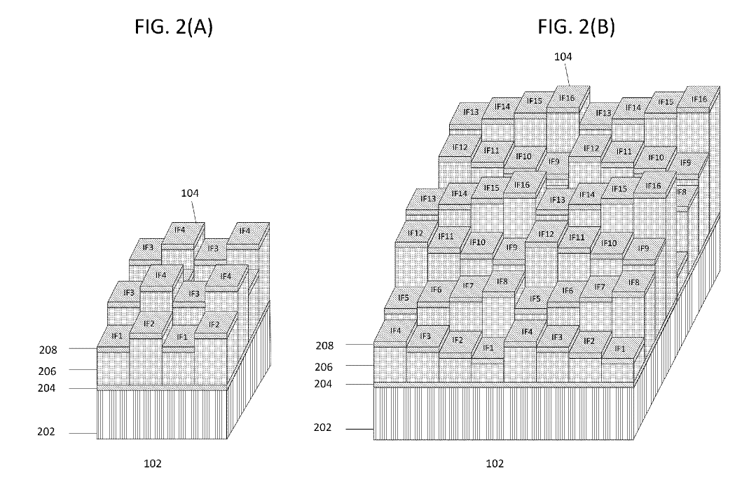

FIGS. 2(a) and 2(b) illustrate an example of a perspective view of a flexible pixelated Fabry-Perot consisting of four blocks 102, where each block 102 has 4 (FIG. 2(a)) or 16 (FIG. 2(b)) different pixels 104 in a mosaic arrangement. The flexible pixelated Fabry-Perot filter 100 is comprised of at least one flexible substrate 202, at least one Fabry-Perot cavity 206 for each pixel 104, and metallic or dielectric mirrors known as the first reflective mirror 208 and the second reflective mirror 204 on the top and bottom of the cavity for each pixel 104, respectively. The flexible substrate 202 may be comprised of flexible polymeric materials such as epoxy, Benzocyclobutene (BCB), SU8, Poly(methyl methacrylate) (PMMA), and Polyethylene terephthalate (PET), as understood in the art. The flexible substrate 202 thickness can be in range of 1 μm and can extend up to a few centimeters. In some example embodiments, the flexible substrate is at least one of a thin film, a polymer material, a microlens array, or a flexible display, for example.

The first reflective mirror 208 and the second reflective mirror 204 are, for example, composed of metal or dielectric. Metallic mirrors can be made of any suitable metal such as gold, silver, or aluminum. An alternative to metallic mirrors are Bragg dielectric mirrors, which comprises stacks of one or more layers of high and low refractive index materials. A thin single layer or thin multilayer stack of high refractive index materials can also behave as a reflective layer when the cavity material has lower refractive index compared to the high refractive index materials of the mirrors. A high refractive index material may have refractive index greater than n=2.2. A thin layer with a gradient in the index of refraction across the thickness can also serve as a reflective layer. A thin layer of materials such as amorphous Silicon, poly crystalline Silicon, uni-crystalline Silicon, Silicon-rich Silicon nitride, Silicon Carbide, Silicon Nitride. Aluminum Arsenide (AlAs), Gallium Arsenide (GaAs), Indium Arsenide (InAs), Boron Carbide (B4C) and Titanium Oxide (TiO2) can be one of the distinguishable high-refractive index materials and can behave as a reflective layer when the difference between refractive index of cavity and high refractive index is greater than 0.5. For example, a thin layer of amorphous silicon (i.e. thickness=30 nm) with refractive index greater than n=4 at 500 nm wavelength can behave as a reflective layer in visible and near infrared range when the cavity material has lower refractive index than amorphous silicon such as n=1.5. The cavity 206 height and the dielectric constant of the material comprising the cavity play a role in tuning the Fabry-Perot transmission resonance wavelength. The transmission of the Fabry-Perot filter is calculated with the following equation:

$${T}_{e} = \frac{{( 1 - R )}^{2}}{1 + {R}^{2} - 2 R cos δ} , δ = ( \frac{2 π}{λ} ) 2 nl cos θ ,$$

where R, n, λ, θ, and δ are mirror reflectance, cavity refractive index, wavelength, incident angle of the light and phase difference. The cavity 206 material may comprise of a polymer or a dielectric film and its thickness can be in a range of a few nanometers to 100 μm.

In some example embodiments, the reflective layer includes thin metal films or dielectric Bragg mirrors or a thin single-layer or multi-layer stack of high refractive index materials. The Bragg mirrors require multiple depositions of high and low refractive index dielectrics, which provides better reflectance efficiency but higher cost compared to metallic mirrors. The reflective mirror may constitute a thin single layer of high refractive index material, multiple layers of different high refractive index materials, or a layer comprised of a material with a gradient in the refractive index. The materials having refractive index greater than n=2.2 are considered as high refractive index material.

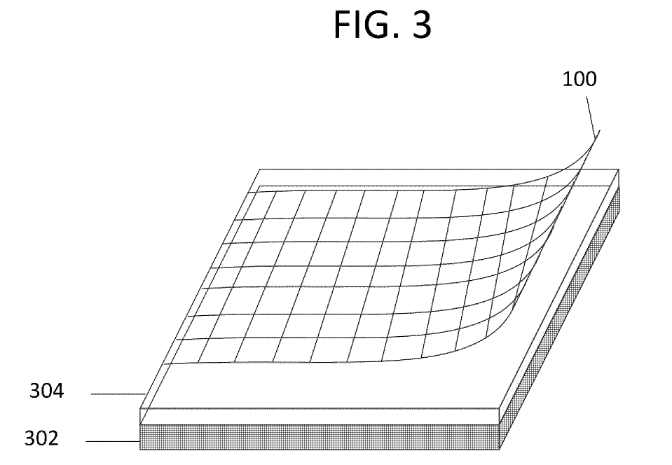

FIG. 3 shows a perspective view of an example of a flexible pixelated Fabry-Perot filter 100 integrated onto the secondary substrate 302. The flexible pixelated Fabry-Perot filter 100 can be integrated or attached to the surface of the secondary substrate 302 with or without a bonding agent 304. The integration can be performed from the top or bottom surface of the flexible pixelated Fabry-Perot filter 100 onto the surface of the secondary substrate 302. The secondary substrate 302 can, for example, be other flexible or hard materials such as flexible or hard digital display, glass, Pyrex™, polymer, Complementary metal-oxide-semiconductor (CMOS) detectors, Charge-coupled device (CCD) detectors, and paper documents. For example, the flexible pixelated Fabry-Perot filter 100 can be directly integrated onto the surface of a CCD and CMOS imaging sensor and can be utilized for color and multispectral imaging applications. In some example embodiments, the flexible pixelated Fabry-Perot filter 100 can be integrated onto a wafer substrate or a reflective substrate. Alignment of each block 102 and pixel 104 with the pixels of the imaging sensor may be required to improve overall imaging performance. In another example, the flexible pixelated Fabry-Perot filter 100 can be designed with red, green, and blue pixels and can be attached to a digital display for generating color digital images. In another example, the flexible pixelated Fabry-Perot filter 100 can be designed to transmit spectral bands to protect or augment human vision and attached to the lenses used in glasses, goggles, visors, sunglasses, and laser protective eyewear. In another example, the flexible pixelated Fabry-Perot filter can be attached to windows in buildings and vehicles to block light within undesirable bands of the electromagnetic spectrum, or transmit bands with desirable characteristics.

Next, we describe integration of flexible pixelated Fabry-Perot filters 100 on to other substrates and devices. A flexible pixelated Fabry-Perot filter can be bonded onto a secondary substrate 302 using optical glues or bonding materials. A bonding agent 304 can, for example, be UV curable polymers or thermal adhesive polymers such as BCB, epoxy, Spin-On Glass (SOG), SU8, and PMMA, as understood in the art. Furthermore, surface chemistry can be performed on the surface of the secondary substrate 302 to improve integration of the flexible pixelated Fabry-Perot filter. Furthermore, mechanical bonding of a flexible pixelated Fabry-Perot filter to the secondary substrate 302 is another example of the embodiment. For example, the flexible pixelated Fabry-Perot filter 100 can be bonded to the surface of a CCD or CMOS imaging sensor for the purpose of performing multispectral, or hyperspectral imaging. Furthermore, the flexible Fabry-Perot filter 100 can be attached to an LCD (Liquid-crystal display) panel and behaves as a color filter array for displaying color images in the visible range. Also, it can be bonded to other optically clear, non-clear, and reflective substrates such as glass, rigid plastic, mirror, and silicon substrates.

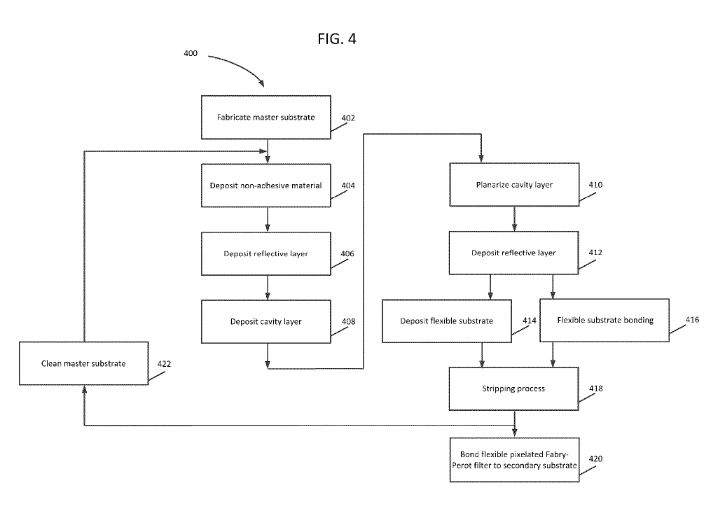

A replication method 400 for manufacturing a flexible pixelated Fabry-Perot filter 100 from a master substrate is provided in FIG. 4. First, a fabricate master substrate process 402 is used to produce a master substrate, which includes the fabrication of pixels into the flat surface of an example material such as silicon, silicon dioxide, or silicon nitride, in some example embodiments. Each pixel on the master substrate is characterized with an area and depth that results in a pixel area and cavity length for pixels of the apparatus. Different pixel depths on the master substrate can be achieved by lithography, deposition, or etching of materials such as silicon, silicon dioxide, silicon nitride, or metals. After designing and fabricating the master substrate, a non-adhesive material is deposited on the surface of the master substrate to facilitate the stripping process 418 of the apparatus from the master substrate and this step is called deposit non-adhesive material process 404. Then, a first reflective mirror 208 material is deposited onto the surface of non-adhesive material in a process called the deposit reflective layer process 406. To form the cavity 206 of the flexible pixelated Fabry-Perot filter 100, a dielectric material such as BCB, SU8, PMMA or SOG is deposited on the top surface of the first reflective mirror 204 (deposit cavity layer process 408) and followed by surface planarization of the cavity material through a planarize cavity layer process 410. The cavity 206 material is spin-coated or deposited, but needs to allow flexibility of the final apparatus. The planarize cavity layer process 410 can be thermal, reflow of material, Chemical Mechanical Polishing/Planarization (CMP), contact planarization or an etch-back method, as understood in the art. Surface planarization minimizes the height differences between pixels and provides predictable device performance. The bottom surface of the cavity 206 has a shape that is complementary to the master substrate surface, which results in Fabry-Perot cavity 206 lengths that are unique to each pixel 104. On other words, the distance between the top surface of the cavity 206 and the bottom surface of the cavity 206 is unique to each pixel 104. A second reflective mirror 204 is then deposited onto the bottom surface of the cavity layer 206 utilizing a deposit reflective layer process 412. A flexible substrate 202 is then coated on top of the surface of the second reflective mirror 204 using a process called the deposit flexible substrate deposition process 414. In another example of embodiment, a flexible substrate 202 is bonded on top of the surface of the second reflective mirror 204 using a process called the flexible substrate bonding process 416. The flexible substrate 202 can, for example, be formed with UV or thermal curable polymers such as SU8, BCB, and epoxy. For example, after spin-coating UV curable polymeric material onto the surface of the second reflective mirror 204 and curing it, the polymeric material forms the flexible substrate 202 of the entire apparatus and it can be detached with the entire flexible pixelated Fabry-Perot filter from the master substrate. Detachment of the flexible pixelated Fabry-Perot filter from the master substrate is facilitated using a stripping process 418 that separates the entire flexible pixelated Fabry-Perot filter 100 from the master substrate. The apparatus can be attached or bonded onto a secondary substrate 302 and this process is called bond flexible pixelated Fabry-Perot filter 100 to secondary substrate process 420. The master substrate can be washed and cleaned for the next replication process of the next apparatus using a process called the clean master substrate process 422.

One skilled in the art will recognize that the order of the steps in the replication method 400 for manufacturing a flexible pixelated Fabry-Perot filter 100 can be rearranged. For example, the deposit reflective layer 406 can be performed after a stripping process 418. Alternatively, the deposit reflective layer process 412 can be directly performed on the flexible substrate 202 and then the flexible substrate 202 coated with the second reflective mirror 204 can be bonded to the cavity 206 material on the master substrate.

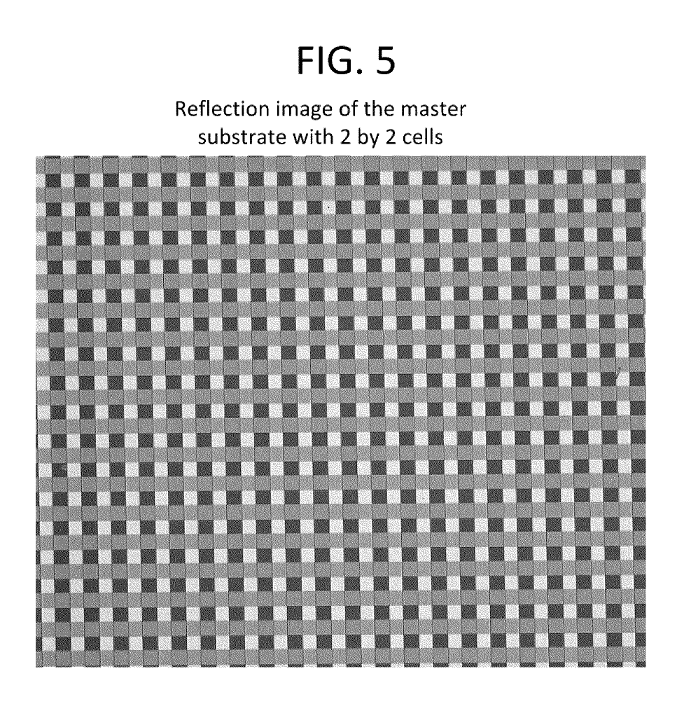

Here, we provide an example method for the fabrication of the master substrate for creating a flexible pixelated Fabry-Perot filter 100. We used a 500 μm thick silicon wafer with 1000 nm thermal oxide grown on the polished side of the silicon wafer. The silicon wafer with 1000 nm SiO2 layer was cleaned in Oxygen plasma for 20 minutes and it was treated with Hexamethyldisilazane (HMDS) adhesion promotor inside a vacuum oven to create an adhesive monolayer for the photoresist spin-coating process. Afterwards, 1805 Shipely photoresist was spin-coated onto the surface of the thermal oxide and soft-baked on a hot-plate at 113° C. for 3 minutes. A one-dimensional array of chromium lines on the glass was used as a mask for the photolithography process. For example, the linewidth of each line was 20 μm and the spacing between two adjacent lines was 20 μm. The photolithography process was performed using a 3.75 second exposure of 12 mW UV light onto the mask, which was in complete contact with the wafer. Then, the sample was developed in MF-319 for 3 minutes, which left behind the photoresist line patterns on the wafer. The wafer was placed in the RIE system for etching the SiO2. First, the wafer was treated with the descum oxygen plasma for 1 minute to remove the developed photoresist residue and then etched for 90 seconds with a combination of CF4 and O2 plasma to create 60 nm deep lines inside the SiO2 layer. The wafer was then placed inside the Acetone solution to remove the photoresist line patterns from the wafer and cleaned under oxygen plasma for 20 minutes to prepare the wafer for the next photolithography process. The line patterns were fabricated on the SiO2 layer. To fabricate a mosaic of four different pixel heights, another lithography process was performed with the same chromium line mask. The wafer was coated with HMDS adhesion promotor and Shipley 1805 photoresist followed by soft-baking at 113° C. for 3 minutes. The wafer was rotated 90 degrees on the mask aligner of the photolithography system with respect to the previous photolithography process (all degrees herein are in Celsius unless otherwise noted). The same photolithography recipe and development process was used to create the photoresist patterns, but at 90 degrees to the first set of patterns. The wafer was etched for 45 seconds in the RIE system under O2 and CF4 plasma. Then, the photoresist was removed from the wafer using Acetone and Oxygen plasma for 20 minutes. The master wafer consisted of blocks of 4 pixels. Each block was 40 μm by 40 μm in size. Each pixel was 20 μm by 20 μm size and had a depth relative to the original SiO2 top surface of 0 nm, 30 nm, 60 nm, or 90 nm. The processed master substrate was used to fabricate replicas of the flexible pixelated Fabry-Perot filters 100. Referring now to FIG. 5, a reflection image 500 taken with a monochromatic camera of the processed master substrate is shown. The image 500 shows the contrast differences attributable to the repeating blocks of four pixels.

One can appreciate that a master substrate with different numbers of blocks and pixels with unique patterns is easily fabricated. For example, a master substrate with repeating blocks of 16 pixels, where each pixel has a unique depth, can be used to produce a 16-band flexible pixelated interference filter 100. To process the master substrate, a 4-step photolithography process can be performed using the chromium line mask technique and the horizontal and vertical alignment marks on the mask. Furthermore, the block and pixel shape and organization can take on many different designs. For example, instead of lines, a mask with square, rectangular, or other shape or pattern can be specially designed to fabricate various numbers and geometries of pixels and blocks.

Next, we describe how to fabricate a flexible pixelated Fabry-Perot filter 100 utilizing the processed master substrate. The SiO2 layer of the master substrate was first coated with a non-adhesive material, followed by deposition of a 40-nm thick layer of gold by electron beam deposition. The gold layer behaves as a partially-reflective mirror for the flexible pixelated Fabry-Perot filter 100. The non-adhesive material provides the ability to peel off the flexible pixelated Fabry-Perot filter 100 from the processed master substrate. Then, the sample was spin-coated with a 400-nm thick layer of SU8, which acted as the cavity 206 layer between mirrors. The SU8 layer was planarized at 150 degrees for 30 minutes and then was UV cured followed by thermal curing at 90 degree for 3 minutes. Planarization can also be done with Chemical Mechanical Polishing/Planarization (CMP) to achieve higher degrees of surface planarization. In another example, a flat substrate with non-adhesive material on its surface can be placed against cavity material on the master substrate to reflow cavity material for surface planarization by applying pressure and temperature between them. Then, a 40-nm thick layer of silver was evaporated onto the sample to provide the secondary mirror of the Fabry-Perot filter cavities. In order to peel-off the entire flexible pixelated Fabry-Perot filter 100, a few microns thick SU-8 was spin-coated onto the surface of the silver, followed by UV exposure, and a thermal curing process. The entire flexible pixelated Fabry-Perot film from edges of the master substrate was peeled off using a tweezer and running Deionized (DI) water onto the master substrate. Other methods of peel-off are possible, such as incorporating compressed air to delaminate the gold from the nonstick layer, or transfer of the flexible pixelated Fabry-Perot filter 100 using a suction-based lift off and transfer apparatus. The master substrate can be cleaned and reused for subsequent replication processes.

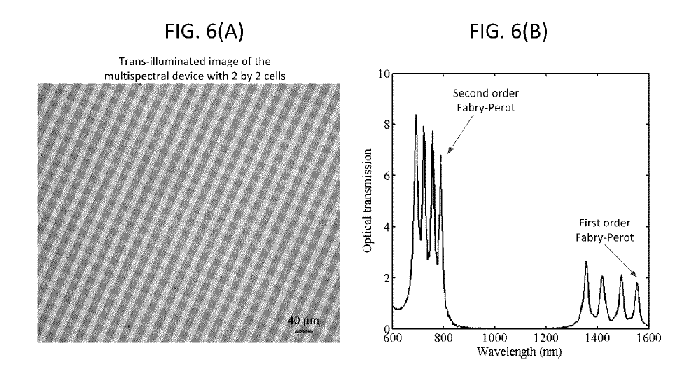

In an example of the embodiment, a flexible pixelated Fabry-Perot filter 100 with repeating blocks 102 of four pixels 104 was fabricated and used for snapshot multispectral imaging at four spectral bands between 650 nm and 810 nm. FIG. 6(a) illustrates a trans-illumination image 600 of the flexible Fabry-Perot filter and FIG. 6(b) illustrates a graph 610 of optical transmission spectra of the flexible Fabry-Perot filter. The flexible pixelated Fabry-Perot filter 100 had both first order 614 and second order 612 Fabry-Perot resonances between 600 nm and 1600 nm. The first order 614 Fabry-Perot resonances were between 1300 nm and 1600 nm and the second order 612 Fabry-Perot resonances were between 650 nm and 800 nm. Each block 102 was 40 μm by 40 μm in size and each pixel 104 was 20 μm by 20 μm in size. The fabricated flexible pixelated Fabry-Perot filter 100 was mechanically bonded to the image sensor of a K4 CCD monochromatic camera (Photometrics Inc.) with pixel size of 6 μm by 6 μm. Each pixel 104 occupied at least two by two complete pixels of the CCD imaging sensor. An imaging lens was attached to the camera for performing snapshot multispectral imaging. The second order FP filters were used within 650 nm and 800 nm for multispectral imaging in four bands. A spectral image was generated from each pixel 104 and associated to pixel 104 wavelength. To test the utility of the device, cuvettes with various concentrations of Methylene Blue (0 μM, 6 μM, 25 μM, and 100 μM) were filled and multispectral images were captured and processed. Methylene blue has absorption peak at 688 nm, which falls off with longer wavelengths.

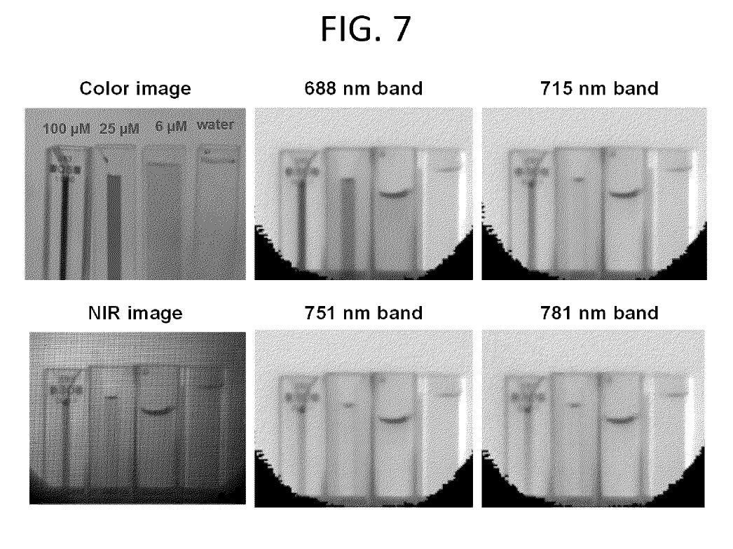

The multispectral and color images of the Methylene blue cuvettes are shown in FIG. 7. Specifically, FIG. 7 shows, for the Methylene blue cuvettes, a color image (originally) 702, an image of 688 nm band 704, an image of 715 nm band 706, an image of NIR 708, an image of 751 nm band 710, and an image of 781 nm band 712. As it was expected the absorption of the Methylene blue was higher in the 688 nm band and lower for the longer wavelengths. There was almost no absorption due to Methylene blue in 751 nm and 781 nm spectral bands. Also, high concentrations of Methylene blue showed higher absorptions at 688 nm and 715 nm bands.

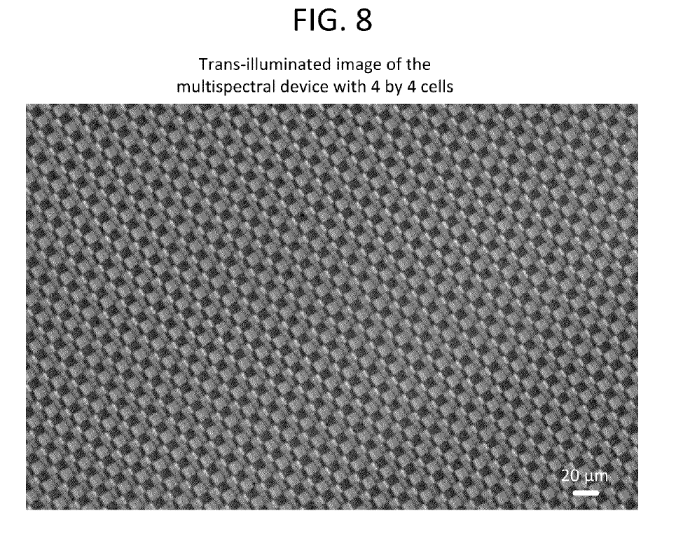

In another example embodiment, a flexible pixelated Fabry-Perot filter 100 with repeating blocks 102 of 16 cells was fabricated and used for snapshot multispectral imaging in 16 spectral bands within 450 nm and 900 nm. FIG. 8 shows a trans-illumination image 800 of a flexible pixelated Fabry-Perot filter 100 having repeating blocks 102 of 16 pixels 104 with first order Fabry-Perot resonances between 450 nm and 900 nm.

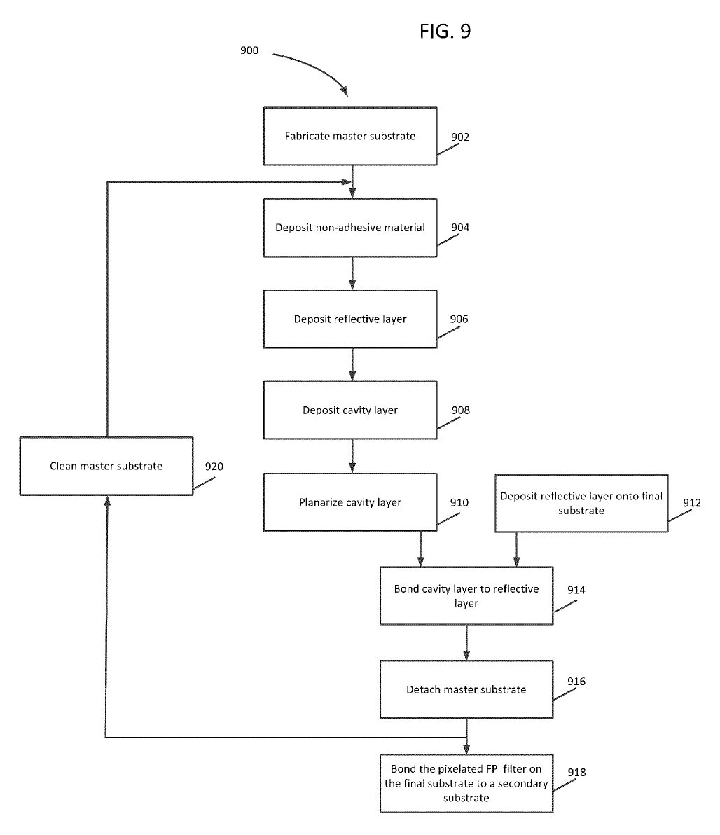

A replication method 900 for manufacturing a pixelated Fabry-Perot filter from a master substrate directly onto a final substrate is provided in FIG. 9. First, a fabricate master substrate process 902 is used to produce a master substrate and it is the same process demonstrated in fabricate master substrate process 402, in an example embodiment. After designing and fabricating the master substrate, a non-adhesive material is deposited on the surface of the master substrate to facilitate the detaching master substrate process 916 of the pixelated Fabry-Perot filter from the master substrate to the final substrate and this step is called deposit non-adhesive material process 904. Then, a first reflective mirror material 208 is deposited onto the surface of non-adhesive material in a process called the deposit reflective layer process 906. To form the cavity of the pixelated Fabry-Perot filter, a dielectric material such as BCB, SU8, PMMA, or SOG is deposited on the top surface of the first reflective mirror 208 (deposit cavity layer process 908) and followed by surface planarization of the cavity material through a planarize cavity layer process 910. The cavity material is spin-coated or deposited, but needs to allow bonding with the final substrate in bond cavity layer to reflective layer process 914. The surface of the final substrate such as glass substrate or CMOS and CCD wafers are cleaned for deposition of a second reflective mirror 204 and this process is called the deposit reflective layer process 912. Then, the second reflective mirror 204 may be coated or deposited with, for example, the same cavity material, which allows bonding with the cavity 206 material on the master substrate. The master substrate and the final substrate can be bonded via adhesive properties of cavity layer, for example, using its UV curing properties or thermal bonding in a wafer bonding machine and this process is called bond cavity layer to reflective layer process 914. After bonding of two substrates, the master substrate is then detached from the second substrate called detach master substrate process 916 and results in transfer of the pixelated Fabry-Perot filter onto the final substrate. Finally, the pixelated Fabry-Perot filter may be bonded to a secondary substrate using a bonding process and this process is called bond the pixelated Fabry-Perot filter on the final substrate to a secondary substrate process 918. The master substrate can be washed and cleaned for the next replication process of the next apparatus using a process called the clean master substrate process 920.

However, one skilled in the art will recognize that variations in the order of the steps within the replication method 900 for manufacturing a pixelated Fabry-Perot filter on to a final substrate are possible. For example, the deposit reflective layer 906 on the filters can be done after the detach master substrate process 916. The replication method 900 can have fewer manufacturing steps. For example, planarize cavity layer process 910 may not require a separate step, since it may be combined with bond cavity layer to reflective layer process 914.

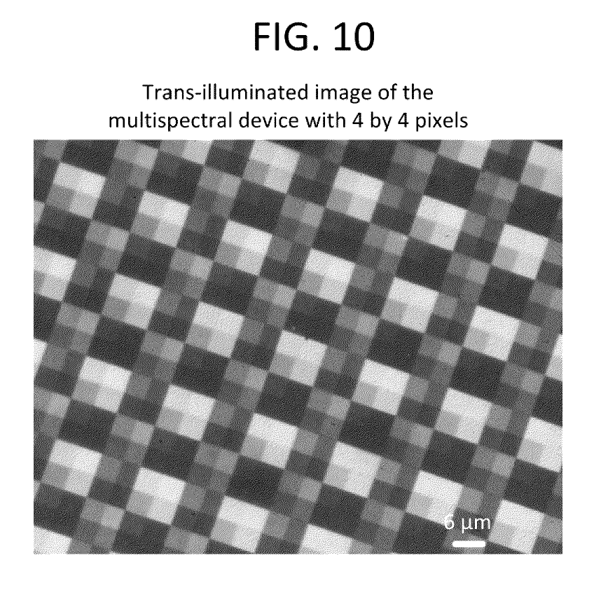

As an example embodiment, a master substrate having 16 different pixels or heights was fabricated into 1 μm thick thermal oxide on the silicon wafer. The height difference between consecutive pixels was 10 nm. The maximum height different was 150 nm between shortest and tallest pixels. Then, the master substrate was coated with 40 nm gold film using electron beam evaporation system and gold film behaves as non-adhesive material to the SiO2 material on the master substrate as well as the first reflective mirror 208. A 180 nm thick BCB material was spin-coated onto the 40-nm gold film and it was partially cured in oven under nitrogen atmosphere. A flat Pyrex substrate was deposited with 3-nm Ti and 40-nm thick gold film and formed the second reflective mirror 204. The master wafer and the flat Pyrex substrate were placed in wafer bonding machine equipped with thermal adjustment, pressure and vacuum. A vacuum and pressure was applied in wafer bonding machine between two substrates and the temperature was raised to reflow and fully-cure BCB cavity material between two substrates. As a result, two substrates are bonded and allow reflowing and planarization of BCB cavity material. Then, the master substrate wafer was detached from the flat Pyrex substrate and resulted in transferring of pixelated Fabry-Perot filter onto the Pyrex substrate. FIG. 10 shows a monochromatic image 1000 of the 16 band pixelated Fabry-Perot filter on the Pyrex substrate. Each pixel is 5.5 μm by 5.5 μm and was designed to be integrated with 4MP CMOSIS imaging sensor (CMV4000) for multispectral imaging in 16 bands within 550 nm and 970 nm. The pixelated Fabry-Perot filter was attached to 4 degree of freedom (x, y, x, and rotation) alignment system to align pixelated Fabry-Perot filter to pixels of the camera, while the camera was capturing images. The monochromatic illumination was used to illuminate pixelated Fabry-Perot filter and they were aligned with camera pixels utilizing a criteria of least cross-contamination between adjacent pixels. After alignment of the pixelated Fabry-Perot filter with the camera pixels, the filter was brought to complete contact with the imaging sensor and an optical glue was used to perform final attachment and bonding of the pixelated Fabry-Perot filter to the imaging sensor.

In some example embodiments, the flexible material of the cavity 206 layer further comprises an absorbing dielectric material. For example, with absorbing material it is possible to obtain different colors as described by Kats et al. in Nature Materials 12, 20-24 (2013), “Nanometre optical coatings based on strong interference effects in highly absorbing media”, incorporated herein by reference.

In some example embodiments, the flexible material of the cavity 206 layer further comprises dielectric layers consisting of gas and solid. For example, the first reflective 208 and second reflective 204 layers are structurally attached to each other with solid material for some of the pixels but the other pixels, there is no attachment between first reflective 208 and second reflective 204 or there is partial attachment of reflective layers with solid materials. Therefore, there exists gas or vacuum for no structurally attached reflective layers.

In some example embodiments, the pixelated Fabry-Perot is bonded to paper, plastic, or bank notes, for authentication applications. In some example embodiments, the pixelated Fabry-Perot filter is part of a flexible and curved display, paper, banknote, coin, polymer film, camera sensor, window glass in a building or vehicle, optical component, eyewear, heads up display, mobile phone display, computer monitor, television display, or lighting.

In an example embodiment, it may be appreciated that there can be provided a means to cost-effectively produce a flexible color filter array at wafer scale that is based on the Fabry-Perot effect or transfers and prints the pixelated Fabry-Perot filter directly onto a final substrate from a master substrate. In an example embodiment, it may be appreciated that the filter may be easily integrated on to a secondary substrate due to its flexibility and amenability to conforming to the receiving surface. In an example embodiment, it may be appreciated that the number of fabrication steps to produce the filter does not depend on the number of wavelength distinct Fabry-Perot filters in the color filter array and does not require multiple lithography, etching, and deposition steps. In an example embodiment, it may be appreciated that the pixelated Fabry-Perot filter can be built as a compact device since all elements can be integrated into one device such as imaging sensor, digital display, and security document. For example, the filter can be utilized in color, multispectral, and hyperspectral imaging devices by integration to any imaging sensor. Furthermore, the filter can also be integrated onto flat, curved, and flexible digital displays. In addition, the filter can also be integrated onto lenses in human vision applications. Moreover, the filter can also be integrated onto windows used in optical, building, aeronautical, space and automotive applications.

Certain adaptations and modifications of the described embodiments can be made. Therefore, the above discussed embodiments are considered to be illustrative and not restrictive. Example embodiments described as methods would similarly apply to systems, and vice-versa.

Variations may be made to some example embodiments, which may include combinations and sub-combinations of any of the above. The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

What is claimed is:

1. A flexible Fabry-Perot filter, comprising:
a first reflective layer;
a second reflective layer;
a Fabry-Perot cavity layer between the first reflective layer and the second reflective layer,
wherein the Fabry-Perot cavity layer includes at least two regions of different cavity thickness; and
a flexible substrate layer which structurally supports the first reflective layer, the Fabry-Perot cavity layer, and the second reflective layer.

2. The filter of claim 1, wherein the cavity layer comprises a flexible material.

3. The filter of claim 1, wherein the flexible material of the cavity layer further comprises a dielectric material.

4. The filter of claim 1, wherein the flexible material of the cavity layer further comprises an absorbing dielectric material.

5. The filter of claim 1, wherein each region of the Fabry-Perot cavity layer and surrounding part of the first reflective layer and surrounding part the second reflective layer collectively function as an individual Fabry-Perot filter and defines a respective pixel.

6. The filter of claim 5, wherein at least one of the pixels results in transmission of at least one of ultraviolet (UV), visible, near-infrared (NIR), mid-infrared (MIR), or far-infrared (FIR).

7. The filter of claim 5, wherein the pixels are of a size and/or proximity to each other such that they are individually detectable.

8. The filter of claim 5, wherein the pixels are of a size and/or proximity to each other such that for one type of pixel an aggregate transmission is collectively detectable.

9. The filter of claim 5, wherein the Fabry-Perot cavity layer defines pixel sets, each pixel set being defined by a subset of the pixels exclusive to the other pixel sets, wherein at least two of the pixels in each pixel set have a different cavity thickness.

10. The filter of claim 9, wherein the individual pixels for one of the pixel sets have a same respective cavity thickness as the individual pixels for another one of the pixel sets.

11. The filter of claim 9, wherein the individual pixels for all of the pixel sets have a same respective cavity thickness.

12. The filter of claim 9, wherein the pixels or the pixel sets are arranged in a repeating pattern.

13. The filter of claim 1, where at least one of the reflective layers is at least one of a metal film, a thin single layer or multilayer stack of high refractive index materials, a combination of metal and dielectric films, a Bragg reflector, an organic material, an opaque film, or a film with a gradient index of refraction.

14. The filter of claim 1, where said filter is bonded to paper, plastic, or bank notes, for authentication applications.

15. The filter of claim 1, where said filter is part of a flexible and curved display, paper, banknote, coin, polymer film, camera sensor, window glass in a building or vehicle, optical component, eyewear, heads up display, mobile phone display, computer monitor, television display, or lighting.

16. The filter of claim 1, wherein the cavity layer comprises a gas.

17. A method for fabricating a flexible Fabry-Perot filter, the method comprising:
fabricating a Fabry-Perot cavity layer directly or indirectly on a surface of a master substrate, wherein the Fabry-Perot cavity layer includes at least two regions of different cavity thickness, wherein the surface of the master substrate corresponds to the different cavity thickness;
fabricating a first reflective layer on one surface of the Fabry-Perot cavity layer; and
fabricating a second reflective layer on an opposing surface of the Fabry-Perot cavity layer.

18. The method of claim 17, where said master substrate is coated with a release agent.

19. The method of claim 17, where said master substrate is a modified silicon wafer.

20. The method of claim 17, where said master substrate is a modified glass wafer, a modified metal surface, a modified ceramic surface, a modified plastic surface, or a modified polymer surface.

21. The method of claim 17, further comprising planarizing a top surface of said cavity layer.

22. The method of claim 17, wherein the second reflective layer is fabricated on said Fabry-Perot cavity layer when the Fabry-Perot cavity layer is still on the master substrate.

23. The method of claim 22, further comprising transferring at least said Fabry-Perot cavity layer and said second reflective layer collectively from said master substrate to a secondary substrate.

24. The method of claim 23, where said secondary substrate is at least one of an optical sensor, a complementary metal-oxide-semiconductor (CMOS) sensor, a charge-coupled device (CCD) sensor, a display, a glass substrate, or a wafer substrate.

25. The method of claim 23, where said regions of different cavity thickness are aligned to features of said secondary substrate.

26. The method of claim 23, wherein fabricating the first reflective layer on the Fabry-Perot cavity layer is performed after said transferring.

27. The method of claim 23, wherein the first reflective layer is fabricated on the surface of the master substrate prior to fabricating the Fabry-Perot cavity layer, the first reflective layer being transferred as part of said transferring.

28. The method of claim 17, further comprising transferring at least said Fabry-Perot cavity layer from said master substrate to a secondary substrate, wherein said secondary substrate is coated with the second reflective layer.

29. The method of claim 28, where said secondary substrate is at least one of an optical sensor, a complementary metal-oxide-semiconductor (CMOS) sensor, a charge-coupled device (CCD) sensor, a display, a glass substrate, a wafer substrate, or a reflective substrate.

30. The method of claim 28, where said regions of different cavity thickness are aligned to features of said secondary substrate.

31. The method of claim 28, further comprising, prior to transferring, fabricating said second reflective layer on said secondary substrate with deposition.

32. The method of claim 28, wherein fabricating the first reflective layer on the Fabry-Perot cavity layer is performed after said transferring.

33. The method of claim 28, wherein the first reflective layer is fabricated on the surface of the master substrate prior to fabricating the Fabry-Perot cavity layer, the first reflective layer being transferred as part of said transferring.

34. The method of claim 22, further comprising transferring at least said Fabry-Perot cavity layer and said second reflective layer collectively from said master substrate to a flexible substrate.

35. The method of claim 34, where said flexible substrate is at least one of a thin film, a polymer material, a microlens array, or a flexible display.

36. The method of claim 34, wherein fabricating the first reflective layer on the Fabry-Perot cavity layer is performed after said transferring.

37. The method of claim 34, wherein the first reflective layer is fabricated on the surface of the master substrate prior to fabricating the Fabry-Perot cavity layer, the first reflective layer being transferred as part of said transferring.

38. The method of claim 17, further comprising transferring at least said Fabry-Perot cavity layer from said master substrate to a flexible substrate, wherein said flexible substrate is coated with a second reflective layer.

39. The method of claim 38, where said flexible substrate is at least one of a thin film, a polymer material, a microlens array, or a flexible display.

40. The method of claim 38, wherein fabricating the first reflective layer on the Fabry-Perot cavity layer is performed after said transferring.

41. The method of claim 38, wherein the first reflective layer is fabricated on the surface of the master substrate prior to fabricating the Fabry-Perot cavity layer, the first reflective layer being transferred as part of said transferring.

42. The method of claim 17, wherein fabricating said first reflective layer is performed on said master substrate with deposition.

43. The method of claim 17, where fabricating said Fabry-Perot cavity layer further comprises fabricating with spin coating.

44. The method of claim 22, wherein fabricating said second reflective layer on said Fabry-Perot cavity layer comprises fabricating with deposition.

45. The method of claim 17, where said master substrate is fabricated with an additive manufacturing method.

46. The method of claim 17, where said master substrate is fabricated with a subtractive manufacturing method.

47. The method of claim 17, where said master substrate is fabricated with lithography.

48. The method of claim 17, where the first reflective layer is at least one of a metal film, a thin single layer or multilayer stack of high refractive index materials, a combination of metal and dielectric films, a Bragg reflector, an organic material, an opaque film, or a film with a gradient index of refraction.

49. The method of claim 22, where at least one of the reflective layers is at least one of a metal film, a Bragg reflector, an organic material, an opaque film, or a film with a gradient index of refraction.

50. The method of claim 17, wherein each region of the Fabry-Perot cavity layer and surrounding part of the first reflective layer and surrounding part the second reflective layer collectively define a respective pixel.

51. The method of claim 17, wherein the cavity layer comprises a flexible material.

52. The method of claim 51, wherein the flexible material of the cavity layer further comprises a dielectric material.

53. The method of claim 51, wherein the flexible material of the cavity layer further comprises an absorbing dielectric material.

54. The method of claim 17, wherein each region of the Fabry-Perot cavity layer and associated part of the first reflective layer and associated part the second reflective layer collectively function as an individual Fabry-Perot filter and defines a respective pixel.

55. The method of claim 22, further comprising fabricating a flexible substrate with spin coating thermal or UV curable polymers or organic material on said second reflective mirror when said second reflective mirror is still on the master substrate.

56. The method of claim 23, further comprising reusing the master substrate to fabricate a second Fabry-Perot filter.
